(19) United States
(12) Patent Application Publication
(10) Pub. No.: US 2026/0056026 A1
(43) Pub. Date: Feb. 26, 2026

(54) METHOD, APPARATUS, DEVICE, AND MEDIUM FOR PROCESSING INFORMATION IN TRAVEL SERVICE

(71) Applicant: TENCENT TECHNOLOGY (SHENZHEN) COMPANY LIMITED, Shenzhen (CN)

(72) Inventors: Erya WEN, Shenzhen (CN); Jia SUN, Shenzhen (CN); Yunqing FAN, Shenzhen (CN); Chao DONG, Shenzhen (CN); Yushuang YU, Shenzhen (CN); Xinchen JIANG, Shenzhen (CN); Fan NI, Shenzhen (CN)

(21) Appl. No.: 19/372,765

(22) Filed: Oct. 29, 2025

Related U.S. Application Data
(63) Continuation of application No. PCT/CN2024/116196, filed on Sep. 2, 2024.

(30) Foreign Application Priority Data
Sep. 15, 2023 (CN) 202311197601.1

(51) Int. Cl. G01C 21/36; G06Q 50/47; G06T 11/60

(52) U.S. Cl. CPC G01C 21/3694; G01C 21/3676; G06Q 50/47; G06T 11/60; G06T 2200/24

(57) ABSTRACT

An information processing method includes: displaying a waiting interface at a pick-up waiting stage, the waiting interface displaying a location identifier of a service provider and a traveling route from the service provider to a pick-up point, the traveling route including a first location where a first traffic light is located, and the first traffic light being a traffic light nearest to the service provider, a traffic light having a distance with the service provider less than a first distance threshold, or a traffic light whose distance from the service provider is less than a preset threshold in a traveling direction of the service provider; displaying status information of the first traffic light on the waiting interface in response to the service provider satisfying a target condition; and after the service provider passes by the first location, eliminating the status information of the first traffic light on the waiting interface.

### CROSS-REFERENCES TO RELATED APPLICATIONS

This application is a continuation of PCT Application No. PCT/CN2024/116196, filed on Sep. 2, 2024, which claims priority to Chinese Patent Application No. 202311197601.1, filed with the China National Intellectual Property Administration on Sep. 15, 2023, and entitled “METHOD, APPARATUS, DEVICE, AND MEDIUM FOR PROCESSING INFORMATION IN TRAVEL SERVICE”, the entire contents of all of which are incorporated herein by reference.

### FIELD OF THE TECHNOLOGY

Embodiments of the present disclosure relate to the technical field of transportation, and in particular, to a method, apparatus, device, and medium for processing information in a travel service.

### BACKGROUND OF THE DISCLOSURE

With continuous progress of science and technologies, online ride-hailing emerges, bringing new experience of traveling for people.

When a passenger hails a car by using an online ride-hailing platform, before getting in the car, a passenger end of the online ride-hailing platform may display, to the passenger, information such as a real-time location, an estimated arrival time, and an estimated traveling route to a pick-up point of a driver, so that the passenger grasps the movement of the driver in real time, and properly manages the time to the pick-up point to wait for the car.

### SUMMARY

Embodiments of the present disclosure provide a method, an apparatus, a device, and a medium for processing information in a travel service, in which a passenger end can display a traveling status of a service provider more accurately. The technical solutions are as follows:

An embodiment of the present disclosure provides a method, performed by a passenger end device, the method including: displaying a waiting interface at a pick-up waiting stage, the waiting interface displaying a location identifier of a service provider and a traveling route from the service provider to a pick-up point, the traveling route including a first location where a first traffic light is located; the first traffic light being a traffic light nearest to the service provider or a traffic light whose distance from the service provider is less than a preset threshold in a traveling direction of the service provider; displaying status information of the first traffic light on the waiting interface in response to the service provider satisfying a target condition; and eliminating the status information of the first traffic light on the waiting interface after the service provider passes by the first location.

The embodiments of the present disclosure further provide an apparatus for processing information in a travel service, the apparatus including: a display module, configured to display a waiting interface at a pick-up waiting stage, the waiting interface displaying a location identifier of a service provider and a traveling route from the service provider to a pick-up point, the traveling route including a first location where a first traffic light is located; the first traffic light being a traffic light nearest to the service provider or a traffic light whose distance from the service provider is less than a preset threshold in a traveling direction of the service provider; the display module being configured to display status information of the first traffic light on the waiting interface in response to the service provider satisfying a target condition; and the display module being configured to eliminate the status information of the first traffic light on the waiting interface after the service provider passes by the first location.

The embodiments of the present disclosure further provide a computer device, the computer device including a processor and a memory, the memory having at least one instruction, at least one program, a code set, or an instruction set stored therein, and the at least one instruction, the at least one program, the code set, or the instruction set being loaded and executed by the processor to implement the method for processing information in a travel service according to the foregoing aspect.

The embodiments of the present disclosure further provide a non-transitory computer-readable storage medium, the computer-readable storage medium having at least one instruction, at least one program, a code set, or an instruction set stored therein, and the at least one instruction, the at least one program, the code set, or the instruction set being loaded and executed by a processor to implement the method for processing information in a travel service according to the foregoing aspect.

### BRIEF DESCRIPTION OF THE DRAWINGS

FIG. 1 is a structural block diagram of a computer system according to an exemplary embodiment of the present disclosure.

FIG. 2 is a method flowchart of a method for processing information in a travel service according to an exemplary embodiment of the present disclosure.

FIG. 3 is a method flowchart of a method for processing information in a travel service according to another embodiment of the present disclosure.

FIG. 4 is a method flowchart of a method for processing information in a travel service according to another embodiment of the present disclosure.

FIG. 5 is a schematic diagram of an interface of a method for processing information in a travel service according to another exemplary embodiment of the present disclosure.

FIG. 6 is a schematic diagram of an interface of a method for processing information in a travel service according to another exemplary embodiment of the present disclosure.

FIG. 7 is a schematic diagram of an interface of a method for processing information in a travel service according to another exemplary embodiment of the present disclosure.

FIG. 8 is a method flowchart of a method for processing information in a travel service according to another embodiment of the present disclosure.

FIG. 9 is a method flowchart of a method for processing information in a travel service according to another embodiment of the present disclosure.

FIG. 10 is a method flowchart of a method for processing information in a travel service according to another embodiment of the present disclosure.

FIG. 11 is an apparatus block diagram of an apparatus for processing information in a travel service according to another embodiment of the present disclosure.

FIG. 12 is a block diagram of a terminal according to another exemplary embodiment of the present disclosure.

### DESCRIPTION OF EMBODIMENTS

To make the objectives, technical solutions, and advantages of the present disclosure clearer, the following further describes implementations of the present disclosure in detail with reference to the accompanying drawings.

### Interpretation of Terms:

The intelligent traffic system (ITS), also known as an intelligent transportation system, refers to a comprehensive system that effectively and comprehensively applies advanced science and technologies (such as an information technology, a computer technology, a data communications technology, a sensor technology, an electronic control technology, an automatic control theory, operations research, and artificial intelligence) to traffic and transportation, service control, and vehicle manufacture, and enhances associations among vehicles, roads, and users, to ensure security, improve efficiency, improve an environment, and save energy. Alternatively,
the intelligent vehicle infrastructure cooperative system (IVICS), also known as a vehicle infrastructure cooperative system, is a development trend of the ITS. The IVICS is a safe, high-efficient, and environmental-friendly road traffic system that implements dynamic real-time information exchange between a vehicle and a vehicle and between a vehicle and a road in an all-round manner by using technologies such as advanced wireless communication and a new generation of Internet, and implements active safety control of vehicles and cooperative management of vehicles and roads based on acquisition and integration of full space-time dynamic traffic information, which implements effective cooperation among pedestrians, vehicle, and roads, ensures safe transportation, and improves traveling efficiency.

In some intelligent transportation technologies, when a passenger hails a car by using an online ride-hailing platform, before getting in the car, a passenger end of the online ride-hailing platform may display, to the passenger, information such as a real-time location, an estimated arrival time, and an estimated traveling route to a pick-up point of a driver, so that the passenger grasps the movement of the driver in real time, and properly manages the time to the pick-up point to wait for the car. However, currently, information displayed by a passenger end is not enough to accurately represent a traveling status of a driver.

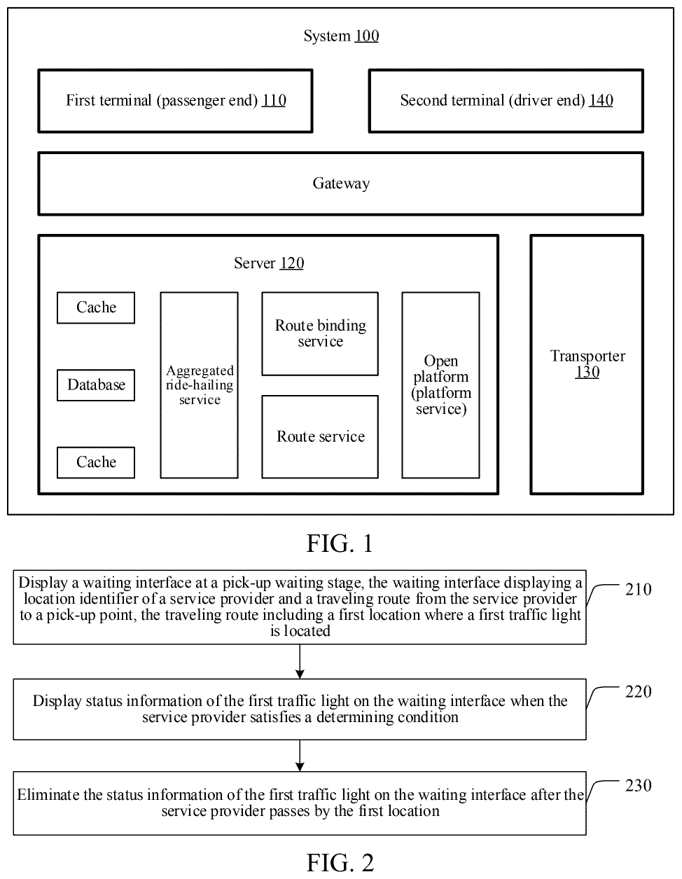

FIG. 1 is a structural block diagram of a computer system according to an exemplary embodiment of the present disclosure. The computer system 100 includes: a first terminal 110, a server 120, a transporter server 130, and a second terminal 140. The computer system may alternatively be referred to as a travel service system, an intelligent transportation system, or an IVICS.

The first terminal 110 may be a mobile terminal such as a smartphone, a tablet computer, or a laptop portable notebook computer. This is not limited in this embodiment of the present disclosure. In an embodiment of the present disclosure, an example in which the first terminal 110 is a smartphone is described. The first terminal 110 is a terminal used by a passenger (which may alternatively be referred to as a passenger end device or a device on a passenger end). A passenger end (a passenger client/a client/a client used by a passenger) of a travel service platform (a travel service application) is installed on the first terminal 110.

The travel service platform may be a service platform that provides a travel service, such as an online ride-hailing platform or a substitute driving service platform. The travel service platform may be implemented by one or more servers. The travel service platform is configured to match a suitable driver according to a travel requirement of a passenger, to meet the travel requirement of the passenger. The travel requirement of the passenger may include: taxi hailing, substitute driving, and running errands. Hence, the travel service application includes at least two types of clients: a passenger end and a driver end. The passenger end includes an application program executable on a computing device of a passenger and is configured to issue a travel order according to the travel requirement, and the driver end includes an application program executable on a computing device of a driver and is configured to receive and execute the travel order.

The second terminal 140 may be a mobile terminal or an in-vehicle terminal. The second terminal 140 is a terminal used by a driver (or referred to as a driver end device, a device on a driver end). A driver end (a driver client/a client used by a driver) of the travel service platform (a travel service application) is installed on the second terminal 140.

Exemplarily, the method provided in the embodiments of the present disclosure can alternatively be applied to other applications having a map. For example, the method may be further applied to a client of a takeout service platform, or applied to a client of an express service platform. That is, the passenger end in this embodiment of the present disclosure is replaced with a client of the takeout service platform, and the driver end in this embodiment of the present disclosure is replaced with a takeout rider end of the takeout service platform. Alternatively, the passenger end in this embodiment of the present disclosure is replaced with a client of the express service platform, and the driver end in this embodiment of the present disclosure is replaced with a courier end of the express service platform.

The server 120 is a server of the travel service platform (the travel service application program), and a serving end of the travel service application program runs on the server 120. The server 120 includes at least one of one server, multiple servers, a cloud computing platform, and a virtualization center. The server 120 is configured to provide a backend service for the clients (the passenger end and the driver end) of the travel service platform. In some embodiments, the server 120 is in charge of primary computing works, and the clients are in charge of secondary computing works; alternatively, the server 120 is in charge of the secondary computing works, and the clients are in charge of the primary computing works; and alternatively, the server 120 and the clients perform collaborative computing by using a distributed computing architecture.

The first terminal 110 and the second terminal 140 are connected to the server 120 through a wireless network or a wired network.

In some other embodiments, the server 120 is a server of an aggregated service platform. The aggregated service platform is configured to aggregate multiple travel service platforms, for providing travel services for passengers. The aggregated service platform may forward a travel requirement of a passenger to multiple travel service platforms (transporters), so as to simultaneously match a driver for the passenger in the multiple travel service platforms. After the matching succeeds, the aggregated service platform and the transporter provide a travel service for the passenger. In some embodiments, the aggregated service platform may have a driver end of the aggregated service platform, or may not have a driver end of the aggregated service platform.

A passenger end of the aggregated service platform is installed on the first terminal 110.

A driver end of a travel service platform (a transporter) may be installed on the second terminal 140.

After a passenger posts a travel order by using a passenger end, the server 120 posts the order to servers (referred to as transporter servers 130 hereinafter) of multiple travel service platforms simultaneously. The multiple transporter servers match a driver for the order. After matching succeeds, the transporter servers 130 transmit a matching result to the server 120, and the server 120 transmits the matching result to the passenger end (the first terminal 110). The transporter servers 130 transmit the matching result to a driver end (the second terminal 140), so that a driver of the driver end provides a travel service for the passenger.

In the foregoing embodiment, the first terminal 110 is connected to the server 120 via a wireless network or a wired network. The second terminal 140 is connected to the transporter server 130 via a wireless network or a wired network. The server 120 is connected to the transporter server 130 via a wireless network or a wired network.

FIG. 2 is a flowchart of a method for processing information in a travel service according to an exemplary embodiment of the present disclosure. The method may be executed by the first terminal shown in FIG. 1. The method includes:

Operation 210: Display a waiting interface at a pick-up waiting stage, the waiting interface displaying a location identifier of a service provider and a traveling route from the service provider to a pick-up point, the traveling route including a first location where a first traffic light is located; the first traffic light being a traffic light nearest to the service provider or a traffic light whose distance from the service provider is less than a preset threshold in a traveling direction of the service provider. The service provider, as used herein, may refer to a service providing vehicle and/or a computing device of a driver.

Exemplarily, the method is performed by a passenger end on the first terminal. The passenger end is a client used by a passenger. The passenger end may be a passenger end of a travel service platform, or may be a passenger end of an aggregated service platform.

The obtaining, by a passenger, a travel service by using a passenger end may include the following several stages: an order editing stage, a matching stage after an order is posted, a pick-up waiting stage after matching succeeds, an in-travel stage after pick-up, and a travel end stage after drop-off.

At the order editing stage, the passenger may edit his or her order requirements on an order editing interface. For example, the order requirements may include: a pick-up point, a destination, a traveling route, and a service type (a vehicle type, a transporter type, and the like).

After edition of the order content is completed, the passenger may trigger an order post control, to post the order, and enter the matching phase. The passenger end transmits an order request to the server, and the server matches a service provider for the passenger end according to the order content carried in the order request, or the server transmits the order request to a transporter server, so that the transporter server matches a service provider for the passenger end.

After the service provider is successfully matched for the passenger end, the pick-up waiting stage is entered.

The pick-up waiting stage refers to a process in which after the service provider is successfully matched for the passenger, the service provider goes from a current location to a pick-up location designated by the passenger, and waits for the passenger to get in the car. For example, the pick-up waiting stage starts from successful matching and ends at pick-up of the passenger. The methods provided in the embodiments of the present disclosure are all performed at the pick-up waiting stage.

At the stage of waiting for the service provider to arrive at the pick-up point, the passenger end displays that the service provider is getting to the pick-up point, marks a current location of the service provider on a map in real time, and displays a traveling route of the service provider from the current location to the pick-up point.

The waiting interface is an interface displayed by the passenger end at the pick-up waiting stage. A map image is displayed on the waiting interface. A location identifier for marking the location of the service provider is displayed on the map image, and a traveling route from the service provider to the pick-up point is further displayed on the map image. The location of the pick-up point is further marked on the map image. The estimated arrival time may further be displayed on the waiting interface. The estimated arrival time is an estimated time at which the service provider (the driver end) arrives at the pick-up point. The waiting interface may further display a distance between the service provider and the pick-up point.

The location identifier may be displayed as an icon (for example, a vehicle icon) with directionality, and one end of the icon (for example, the vehicle head of the vehicle icon) may be configured for indicating a current traveling direction of the service provider. The location identifier is updated in real time according to a real-time location of the driver end.

The traveling route is a connection line connecting the current location (the location marked by the location identifier) of the service provider and the pick-up point. The traveling route may be obtained by sequentially connecting at least one line segment. The traveling route is configured for guiding the service provider to arrive at the pick-up point. The traveling route is a route planned by the travel service platform for the driver end. The service provider may head to the pick-up point according to the traveling route to pick up the passenger, or may plan a route to the pick-up point to pick up the passenger.

For example, the traveling route is also updated in real time. As the location of the service provider changes in real time, the traveling route also changes. The traveling route is always a connection line connecting the location identifier of the service provider and the pick-up point.

The traveling route may pass by a traffic light, or may not pass by a traffic light. This embodiment of the present disclosure is described by using an example in which the traveling route passes by at least one traffic light. The first traffic light is any passed traffic light on the traveling route. In a process in which the service provider heads to the pick-up point, the first traffic light may be a traffic light nearest to the service provider in the traveling direction of the service provider, or may be a traffic light whose distance from the service provider is less than a preset threshold in the traveling direction of the service provider. The first traffic light is located at the first location on the map image, and the traveling route includes the first location.

The service provider refers to the driver end, or the service provider refers to a terminal on which the driver end runs. In a ride-hailing scenario, the service provider may be a driver end used by a driver who drives a vehicle. In a substitute driving scenario, the service provider may be a driver end used by a substitute driving person. In a takeout scenario, the service provider may be a driver end (a takeout courier end) used by a takeout courier. In an express scenario, a service provider may be a driver end (a courier end) used by a courier.

The pick-up point is a place that is selected by the passenger at the order editing stage and that needs to be arrived at by the driver end at the pick-up waiting stage.

In a ride-hailing scenario, the pick-up point is a place where a driver and a passenger meet. The driver (the driver end) needs to drive the vehicle to arrive at the pick-up point and pick up the passenger (the passenger end).

In a substitute driving scenario, the pick-up point may be a place where a driver and a passenger meet (the pick-up point is a location where the passenger is located, and the vehicle is parked at another location). After the driver meets the passenger at the pick-up point, the passenger leads the driver to the place where the vehicle is parked, and execution of an order is started from the place where the vehicle is parked, to enter the in-travel stage. Alternatively, in a substitute driving scenario, the pick-up point may be a place where a driver and a passenger meet (the pick-up point is a location where the passenger and the vehicle are located), and the driver meets the passenger at the pick-up point and drives the vehicle to start to execute an order, to enter the in-travel stage. Alternatively, in a substitute driving scenario, the pick-up point may be a location where a vehicle is located, and a driver arrives at the location where the vehicle is located and drives the vehicle to start to execute an order, to enter the in-travel stage. In this case, the passenger may get to the pick-up point to meet the driver, or the passenger may require the driver to first meet the passenger to get the vehicle key and then head to the pick-up point (a vehicle parking place) to pick up the vehicle. That is, in a substitute driving scenario, the pick-up point may not be a place where execution of an order starts. In a substitute driving scenario, the pick-up point may be one of the following places: a place where a passenger is located, a meeting place designated by a passenger, and a place where a vehicle is located.

In a takeout scenario, the pick-up point may be a meal delivery place designated by a passenger (customer). In a takeout running errands scenario, the pick-up point may be a goods pick-up location designated by a passenger (customer), or the pick-up point may be a delivery place designated by a passenger (customer).

In an express scenario, the pick-up point may be a delivery place designated by a passenger (customer). In an express scenario, the pick-up point may alternatively be a goods pick-up location designated by a passenger (customer).

Operation 220: Display status information of the first traffic light on the waiting interface in response to the service provider satisfying a target condition.

Exemplarily, the first traffic light is a next traffic light that the service provider is about to pass by.

To help the passenger end estimate a passing status of the service provider on the next traffic light, the status information of the traffic light is displayed on the passenger end.

The status information is configured for indicating a real-time status of the first traffic light. The status information includes at least one of the following: a light-on status and countdown (read seconds/number of remaining seconds) corresponding to the light-on status.

The light-on status may include a light-on status in at least one direction, and/or a light-on status corresponding to at least one passing manner. The direction includes: at least one of going straight, turning left, or turning right. The passing manner includes: at least one of a motor vehicle, a non-motor vehicle, or a pedestrian.

For example, the light-on status may be a light-on status in a straight-going direction, or may be a light-on status in a left-turning direction. The light-on status may be a light-on status of a motor vehicle, or may be a light-on status of a non-motor vehicle. The light-on status includes one of the following states: a red light, a green light, or a yellow light.

In some embodiments, the light-on status may be a light-on status of the first traffic light in the traveling direction of the service provider, and the light-on status may be a light-on status corresponding to the passing manner of the service provider. For example, if the traveling route indicates turning left on a first traffic light and the passing manner of the service provider is a motor vehicle, the light-on status is a light-on status corresponding to turning left of a motor vehicle.

The countdown refers to countdown corresponding to the light-on status.

Exemplarily, the status information of the first traffic light displayed by the passenger end is updated and displayed in real time. For example, when the status information includes countdown, the countdown displayed by the passenger end is read in real time.

In some embodiments, when the status information includes a light-on status and countdown corresponding to the light-on status, a display style of the status information may be: displaying the countdown, and determining a display color of the countdown according to the light-on status. For example, red countdown is displayed for the red light, and green countdown is displayed for the green light. Alternatively, the display style of the status information may be: displaying a color icon corresponding to the countdown and the light-on status. For example, countdown and a red icon are displayed, or countdown and a green icon are displayed.

In some embodiments, the status information may be displayed on a fixed location of the waiting interface, for example, displayed on the top of the waiting interface in a form of a bubble. The status information may further be displayed on a peripheral side of a location of the first traffic light, for example, displayed, in a form of a bubble, on a second location having a distance with the first location less than a distance threshold.

Operation 230: Eliminate the status information of the first traffic light on the waiting interface after the service provider passes by the first location.

Exemplarily, after the service provider passes by the first traffic light, the passenger end no longer displays the status information of the first traffic light.

Exemplarily, at the pick-up waiting stage, the passenger end continuously obtains a next traffic light of the service provider in the traveling direction of the passenger end, determines the next traffic light as the foregoing first traffic light, and continues to perform operation 220 and operation 230 until there is no more traffic light on the traveling route, or the service provider arrives at the pick-up point.

Subsequently, the service provider waits at the pick-up point for the passenger to get in the car. After the passenger gets in the car, the in-travel stage is entered. After the passenger is transported to a destination, the passenger gets off the car. The travel end stage is entered, and this service ends.

In conclusion, according to the method provided in this embodiment, at the pick-up waiting stage, the passenger end displays the status information of the traffic light nearest to the service provider in the traveling direction of the service provider, and according to the status information of the traffic light and a real-time location and a real-time driving speed of the service provider, whether the service provider can successfully pass the traffic light can be accurately estimated. Because a waiting time of the traffic light greatly affects an arrival time of the service provider, a traffic situation of the service provider at the traffic light can be accurately estimated by displaying the status information of the traffic light, so as to determine the arrival time of the service provider, thereby improving the information transmission efficiency of the passenger end.

Exemplarily, an exemplary embodiment of displaying the status information of the traffic light is provided.

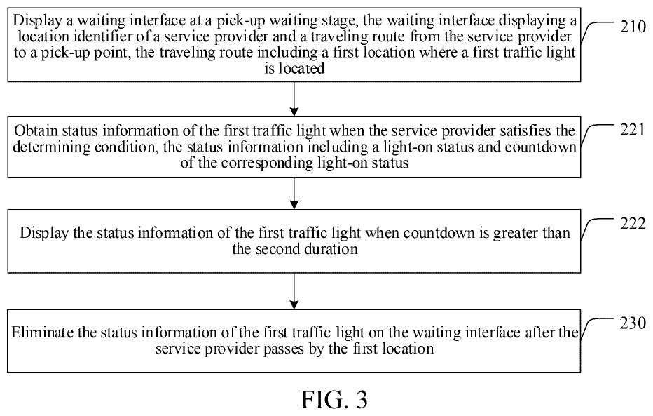

FIG. 3 is a flowchart of a method for processing information in a travel service according to an exemplary embodiment of the present disclosure. The method may be executed by the first terminal shown in FIG. 1. Based on the embodiment shown in FIG. 3, operation 220 further includes operation 221 and operation 222.

Operation 210: Display a waiting interface at a pick-up waiting stage, the waiting interface displaying a location identifier of a service provider and a traveling route from the service provider to a pick-up point, the traveling route including a first location where a first traffic light is located; the first traffic light being a traffic light nearest to the service provider or a traffic light whose distance from the service provider is less than a preset threshold in a traveling direction of the service provider.

Exemplarily, before operation 221, the first traffic light may not be marked on the first location on the waiting interface. That is, which intersection has a traffic light is not marked on the traveling route. Alternatively, the first traffic light may be marked at the first location on the waiting interface. That is, all passing traffic lights are marked on the traveling route.

Operation 221: Obtain status information of the first traffic light when the service provider satisfies the target condition, the status information including a light-on status and countdown of the corresponding light-on status.

Exemplarily, the service provider is located at a first road section of the traveling route, and the first traffic light is located at a destination location of the first road section. The target condition includes at least one of the following conditions:
condition 1: a distance between the service provider and the pick-up point is less than a first distance threshold;
condition 2: a distance between the service provider and the first location is less than a second distance threshold;
condition 3: a first distance is less than a second distance; the first distance is a distance between the service provider and a starting location of the first road section; and the second distance is a distance between the first location and the starting location of the first road section; or
condition 4: a movement distance of the service provider within a first duration is less than a third distance threshold.

The first distance threshold in the condition 1 is configured for determining whether the service provider approaches the pick-up point. When the service provider is far away from the pick-up point, the duration for which the service provider waits for the traffic light has little impact on the estimated arrival time, and the status information of the traffic light may not be presented to the passenger. For example, when the service provider is 10 kilometers (km) away from the pick-up point, the service provider needs half an hour to get to the pick-up point, and several seconds of waiting for the traffic light has relatively little impact on the estimated arrival time. When the service provider is relatively close to the pick-up point, because the time for the service provider to wait for the traffic light has a large impact on the estimated arrival time, the status information of the traffic light needs to be presented to the passenger, so that the passenger can accurately estimate the arrival time of the service provider and properly arrange the itinerary. For example, when a service provider is 1 km away from the pick-up point, the service provider may only need one minute to get to the pick-up point, and then the time of waiting for the traffic light has a large impact on an accurate time when the service provider finally arrives.

The second distance threshold in the condition 2 is configured for determining the distance between the service provider and the first traffic light. The status information of the first traffic light is displayed only when the service provider approaches the first traffic light; and if the service provider is far away from the first traffic light, the status information of the first traffic light does not need to be presented.

The condition 3 is configured for determining that the service provider has not passed by the first location. For example, the service provider is located at the first road section, and the first traffic light is located at the destination location (the first location) of the first road section. When the distance between the service provider and the starting location is less than the distance between the starting location and the destination location, it can be determined that the service provider has not passed by the first traffic light.

The condition 4 is configured for determining whether the service provider is traveling at a low speed. If the service provider is traveling at a low speed, it can be reckoned that the service provider is probably waiting for the traffic light. If the service provider is traveling at a low speed and the first traffic light is the red light, it can be determined that the service provider is waiting for the green light. If the service provider is traveling at a low speed and the first traffic light is the green light, it can be determined that the road is congested.

The first distance threshold, the second distance threshold, the third distance threshold, and the first duration are all preset values. The first distance threshold is greater than the second distance threshold, and the second distance threshold is greater than the third distance threshold.

In some embodiments, when the service provider satisfies the target condition, the passenger end obtains the status information of the first traffic light. The status information includes a light-on status of the first traffic light and countdown of the light-on status.

The manner in which the passenger end obtains the status information of the first traffic light may be requesting the server to obtain the status information of the first traffic light, or waiting for the server to actively deliver the status information of the first traffic light.

Operation 222: Display the status information of the first traffic light when countdown is greater than the second duration.

For example, according to specific content of the status information, the passenger end may display the status information in a corresponding display manner.

Case 1: Display the status information of the first traffic light when the countdown is greater than the second duration.

Exemplarily, when the remaining number of read seconds for the countdown is relatively long, the passenger end displays the status information of the first traffic light. In addition, when the light-on status is the red light being on, prompt information that the service provider is waiting for the green light may be further displayed, to prompt the passenger that the service provider is waiting for the green light.

In some embodiments, when the light-on status is the red light being on and the countdown is greater than the second duration, the status information of the first traffic light and the prompt information that the service provider is waiting for the green light are displayed. Alternatively, when the light-on status is the green light being on and the countdown is greater than the second duration, the status information of the first traffic light is displayed.

Case 2: Skip displaying the status information of the first traffic light when the countdown is less than or equal to the second duration.

Exemplarily, when the remaining number of read seconds for the countdown of the traffic light is relatively short, the passenger end may not need to display the status information of the first traffic light.

In some embodiments, when the light-on status is the red light being on and the countdown is less than or equal to the second duration, the status information of the first traffic light is not displayed. Alternatively, when the light-on status is the green light being on and the countdown is less than or equal to the second duration, the status information of the first traffic light is not displayed.

In the case 1, if the countdown is performed from a value greater than the second duration to a value less than the second duration, the passenger end still normally displays the status information of the first traffic light. In the case 2, only when the countdown of the first traffic light that is first obtained by the passenger end is less than the second duration, the passenger end may not display the status information of the first traffic light.

In some embodiments, when the light-on status of the first traffic light that is first obtained by the passenger end is the red light and the countdown is less than the second duration, the passenger end does not display status information of the first traffic light. If the service provider fails in passing through the intersection before ending of the first green light after the current red light, the passenger end displays the status information of the first traffic light during the next red light.

Case 3: Display a traffic light identifier at the first location and prompt information that the service provider is waiting for the green light when the status information is not obtained.

Exemplarily, if the passenger end fails in obtaining the status information of the first traffic light from the server, the passenger end may display the traffic light identifier at the first location, to notify the passenger that there is a traffic light at the location. If the service provider is traveling at a low speed, it may be reckoned that the service provider is waiting for the green light, and the prompt information that the service provider is waiting for the green light is displayed on the passenger end, to prevent the passenger from having an anxiety emotion by seeing that the service provider does not move for a long time. In another embodiment, the prompt information may indicate that the service provider is goring through the traffic light.

Case 4: Display the status information of the first traffic light and prompt information of road congestion when a movement distance of the service provider within the first duration is less than the third distance threshold and the light-on status is the green light being on.

Exemplarily, if the first traffic light is in a green light state, and the service provider moves at a low speed, it can be determined that the current road is congested. The passenger end may display the status information of the first traffic light (the countdown of the green light and the green light), and display the prompt information of road congestion.

Case 5: Display the status information of the first traffic light when the light-on status is the green light being on, where the status information includes the light-on status being the green light and countdown of the green light.

Exemplarily, regardless of whether the status of the first traffic light is the red light, the green light, or the yellow light, before the service provider approaches the first traffic light or passes by the first traffic light, the passenger end displays the status information of the first traffic light in real time.

Both the first duration and the second duration are preset values. The first duration and the second duration are not necessarily associated, and the first duration and the second duration may be equal or not equal.

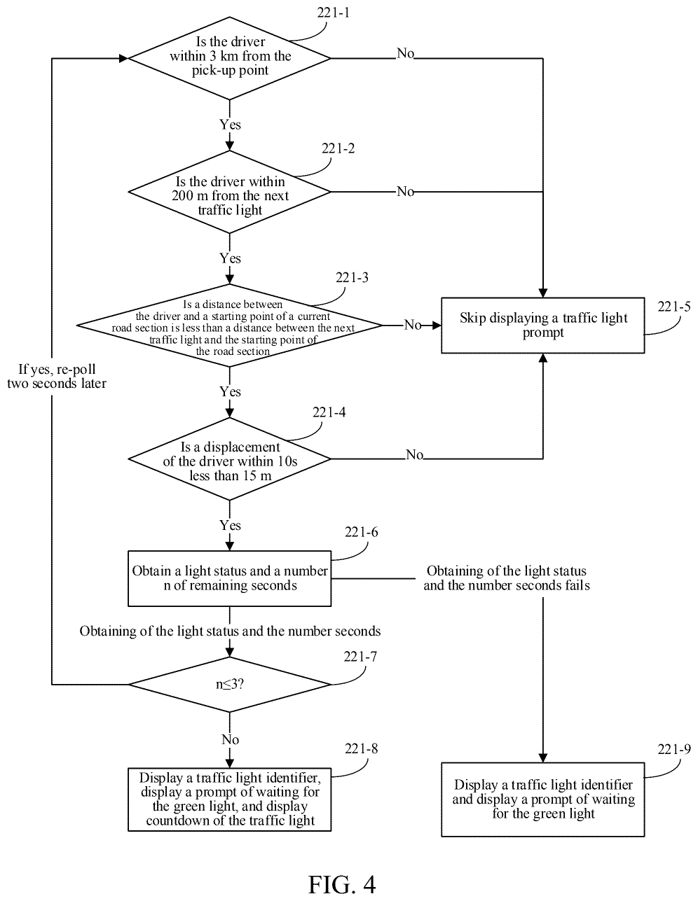

In some embodiments, for example, the first traffic light is a next traffic light in the traveling direction of the service provider, the passenger end may execute a determining process shown in FIG. 4, to determine whether to obtain the status information of the first traffic light, how to obtain the status information of the next traffic light, and how to display the status information of the next traffic light. Operation 221 includes operation 221-1 to operation 221-6, and operation 222 includes operation 221-7 to operation 221-9.

Operation 221-1: Determine whether a distance between the service provider and the pick-up point is less than a first distance threshold (for example, 3 km).

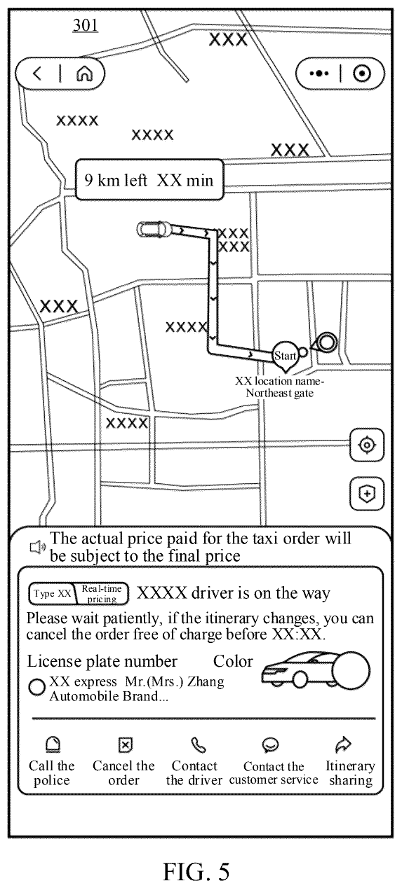

When the distance between the service provider and the pick-up point is less than the first distance threshold, operation 221-2 is continuously performed. When the distance between the service provider and the pick-up point is greater than or equal to the first distance threshold, operation 221-5 is performed: skipping obtaining status information of the next traffic light, and further skipping displaying the status information of the next traffic light. For example, as shown in FIG. 5, the prompt information of the traffic light is not displayed on a waiting interface 301.

Considering that when the service provider is far away from the pick-up point, the passenger does not pay attention to a specific traveling status of the service provider, displaying of a traffic light is redundant information on the contrary. Therefore, the passenger end may first determine that “the service provider is within 3 km from the pick-up point”.

Operation 221-2: Determine whether a distance between the service provider and the next traffic light is less than a second distance threshold (for example, 200 meters).

When the distance between the service provider and the next traffic light is less than the second distance threshold, operation 221-3 is continuously performed, or operation 221-3 may not be performed, and instead, operation 221-4 is directly performed. When the distance between the service provider and the next traffic light is greater than or equal to the second distance threshold, operation 221-5 is performed: skipping obtaining status information of the next traffic light, and further skipping displaying the status information of the next traffic light.

Operation 221-3: Determine whether a distance between the service provider and a starting point of a current road section is less than a distance between the next traffic light and the starting point of the road section.

When the first distance between the service provider and the starting location of the first road section (that is, the current road section in the traveling route on which the service provider is located) is less than the second distance between the first location and the starting location of the first road section, operation 221-4 is continuously performed. When the first distance between the service provider and the starting location of the first road section is greater than or equal to the second distance between the first location and the starting location of the first road section, operation 221-5 is performed: skipping obtaining status information of the next traffic light, and further skipping displaying the status information of the next traffic light.

Whether there is a traffic light (the service provider is within 200 meters from the nearest traffic light) ahead, and whether the service provider has not passed by the traffic light (in a road section, a distance between the service provider and a starting point of the road is less than a distance between the traffic light and the starting point of the road) are determined.

Operation 221-4: Determine whether a displacement of the service provider within the first duration (for example, 10 seconds) is less than a third distance threshold (for example, 15 meters).

When a movement distance of the service provider within the first duration is less than the third distance threshold, operation 221-6 is continuously performed. When the movement distance of the service provider within the first duration is greater than or equal to the third distance threshold, operation 221-5 is performed: skipping obtaining status information of the next traffic light, and further skipping displaying the status information of the next traffic light.

Considering that in a smooth traveling situation, presenting green light information is not helpful to the passenger, the information of the traffic light is not to be presented in this situation. However, in a special scenario: although the light status is the green light, the service provider is actually still in a state of waiting for the green light as the road is congested. Therefore, the passenger end does not simply present only the red light and does not present the green light, but instead, performs determining by using a traveling speed (the displacement within 10 seconds is less than 15 meters) of the service provider combined with a congestion status of the road section, and if the service provider is traveling at a low speed and the road is congested, it is determined that the service provider is in a state of waiting for the green light. By combining the congestion situation, a misjudgment that “the vehicle is exceptionally traveling at a low speed and is not actually waiting for the green light” may be avoided. Exemplarily, whether to combine congestion data may further be determined according to factors such as an actual data interface capability and performance.

Operation 221-6: The passenger end requests the server to obtain status information of the next traffic light. The status information of the next traffic light includes a light-on status (a light status) and countdown (a number n of remaining seconds).

When the status information is successfully obtained, operation 221-7 is continuously performed.

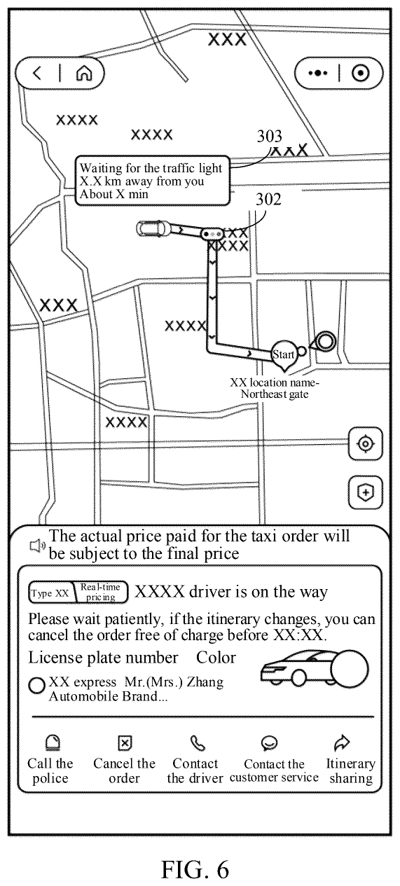

When the status information is not successfully obtained, operation 221-9 is performed: The passenger end displays a traffic light identifier at the first location and displays prompt information that the service provider is waiting for the green light. For example, as shown in FIG. 6, a traffic light identifier 302 is displayed at a first location on a map image, and prompt information 303 of waiting for the green light is displayed.

Restricted by an actual data source, sometimes the server may have no traffic light data, and in this case, when the service provider is in a status of waiting for the green light, only “waiting for the green light” is presented, and countdown information is not presented.

Operation 221-7: Determine whether the countdown n is less than or equal to the second duration (for example, 3 seconds).

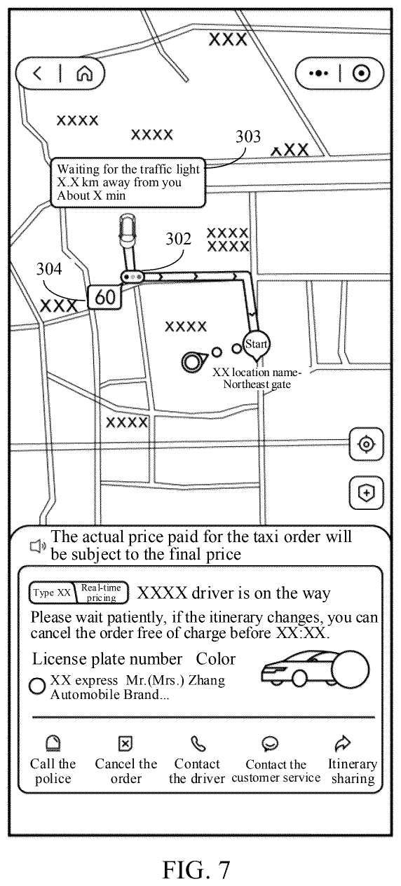

When the countdown is less than or equal to the second duration, operation 221-1 is performed again after a third duration (for example, 2 seconds), to continue to determine, according to a latest status of the service provider, whether the status information of the next traffic light needs to be displayed. When the countdown is greater than the second duration, operation 211-8 is performed: displaying the status information of the next traffic light. For example, as shown in FIG. 7, a traffic light identifier 302 is displayed at a first location on a map image, prompt information 303 of waiting for the green light is displayed, and countdown 304 of the next traffic light is further displayed.

If information of the traffic light is still presented after the passenger end obtains the remaining number of seconds for countdown of the traffic light to find that the traffic light is going to switch within less than three seconds, the passenger end may have the feeling of “the traffic light briefly appeared, and disappeared after one or two seconds”. For this case, the passenger end does not present information of a traffic light that is less than three seconds. If the number of seconds for the countdown is greater than three seconds, the information of the traffic light is normally displayed.

Operation 230: Eliminate the status information of the next traffic light on the waiting interface after the service provider passes by the first location.

Exemplarily, when the first distance is greater than or equal to the second distance, the status information of the next traffic light is no longer displayed. The first distance is a distance between the service provider and the starting location of the first road section. The second distance is a distance between the first location and the starting location of the first road section. The first road section is a road section taking a next traffic light as a destination on the traveling route.

In conclusion, according to the method provided in this embodiment, at the pick-up waiting stage, the passenger end may calculate the distance between the service provider and the next traffic light in real time, and when the service provider is about to get to the pick-up point and the service provider approaches the next traffic light, the status information of the next traffic light is displayed on the passenger end. This helps the passenger accurately estimate an arrival time of the service provider according to the status information of the next traffic light, relieves an anxiety emotion of the passenger during a process of waiting for a pick-up, increases the authenticity of waiting experience, lowers the order cancellation rate, and improves the public praise by users.

Exemplarily, an exemplary embodiment in which a passenger end, a server, and a transporter server jointly perform the information processing method provided in the present disclosure is provided.

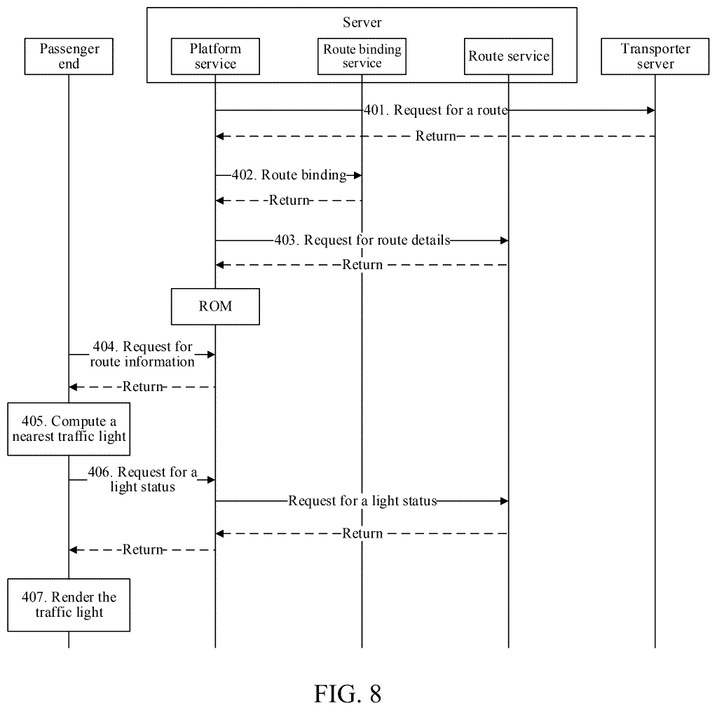

FIG. 8 is a flowchart of a method for processing information in a travel service according to an exemplary embodiment of the present disclosure. The method may be performed by the first terminal, the server, and the transporter server in FIG. 1. The server includes: a platform service for communicating with a passenger end and a transporter server and coordinating services in the server, a route binding service for binding a route provided by the transporter server to a map of the local platform, and a route service for providing route information and a real-time road condition. This embodiment is described by using an example in which the server is a server of an aggregated service platform, and the transporter server is a server of a travel service platform aggregated by the aggregated service platform. The method includes the following operations:

Operation 401: After a transporter server successfully matches a driver for a passenger, a platform service requests, from the transporter server, a traveling route from the driver to a pick-up point. The transporter server returns the traveling route to the platform service.

Because the map used by the transporter server may be inconsistent with the map used by the aggregated service platform (there is a deviation in map information), the server needs to align the traveling route provided by the transporter server to the map used by the server.

The platform service requests the traveling route from the transporter server, and the transporter server returns a route point string (an initial traveling route).

Operation 402: The platform service transmits the traveling route provided by the transporter server to a route binding service, and requests the route binding service to bind the traveling route to a map. After successfully binding the traveling route to the map, the route binding service returns the bound traveling route to the platform service.

Exemplarily, the traveling route provided by the transporter server includes a route point string. The route point string includes latitude and longitude coordinates of at least one point on the traveling route. The route binding service may bind the traveling route to a map of the platform of the route binding service according to the latitude and longitude coordinates. The route binding service may further mark names and/or road section identifiers of road sections on the traveling route.

The platform service transmits the route point string to the route binding service, matches the route point string with a map road network used by the passenger end, and supplements related road network identification information.

Operation 403: The platform service transmits the bound traveling route to a route service, to request the route service to supplement route details. After supplementing the route details according to the traveling route, the route service returns a processed traveling route to the platform service. In this way, the platform service may obtain a final traveling route, and store the final traveling route.

The route details may include at least one of a real-time road condition or traffic light information. The route service may supplement a real-time road condition of at least one road section on the traveling route, and may further supplement information of a traffic light on the traveling route.

Operation 404: A passenger end requests route information of the traveling route and a current location of a driver end from the platform service. The platform service transmits the stored final traveling route and the current location of the driver end to the passenger end.

The passenger end transmits a route obtaining request to the server at a pick-up waiting stage, and receives a real-time route transmitted by the server, the real-time route including a location of the service provider (the driver) and a traveling route on which the driver drives to the pick-up point; and the passenger end displays a waiting interface according to the real-time route.

After receiving the traveling route, the passenger end corrects the location of the driver according to information such as the location, direction, and speed of the driver, to match the location of the driver with the traveling route.

Operation 405: The passenger end calculates a traffic light nearest to the driver according to the location of the driver. A determining process shown in FIG. 4 is performed. When it is determined that the status information of the traffic light needs to be displayed, operation 406 is performed.

Exemplarily, the passenger end determines the first traffic light nearest to the service provider on the traveling route; transmits a light-on status obtaining request to the server when the service provider satisfies the target condition, the light-on status obtaining request being configured for requesting to obtain status information of the first traffic light; receives the status information of the first traffic light transmitted by the server; and displays the status information of the first traffic light.

Operation 406: The passenger end requests the status information of the nearest traffic light from a platform service. The platform service requests the status information of the nearest traffic light from the route service. The route service returns the status information of the nearest traffic light to the platform service. The platform service returns the status information of the nearest traffic light to the passenger end.

Operation 407: The passenger end renders and displays the status information of the traffic light after obtaining the status information of the traffic light.

Exemplarily, if the driver changes the route in the halfway, the transporter server synchronously updates the traveling route to the serving end in real time, and the foregoing operations may be performed again to update the traveling route displayed on the passenger end.

In conclusion, according to the method provided in this embodiment, at the pick-up waiting stage, after obtaining the traveling route from the server, the passenger end may calculate the distance between the service provider and the next traffic light in real time, and when the service provider approaches the next traffic light, request the server for obtaining the status information of the traffic light in real time. Therefore, the passenger end displays the status information of the next traffic light in real time, and the passenger determines a traveling status of the service provider combined with the status of the traffic light. By enriching the traffic light data at the pick-up waiting stage, the waiting anxiety of the passenger is relieved, the authenticity of waiting experience is also increased, the order cancellation rate is further lowered, and the public praise by users is improved.

Exemplarily, the determining process shown in FIG. 4 may alternatively be performed by a platform service.

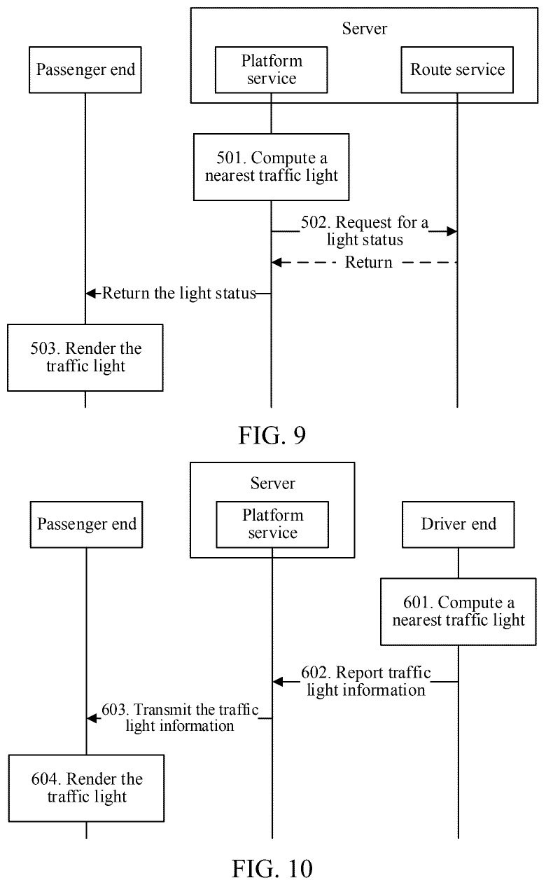

FIG. 9 is a flowchart of a method for processing information in a travel service according to an exemplary embodiment of the present disclosure. The method may be performed by the first terminal and the server in FIG. 1. The server includes: a platform service for communicating with a passenger end and a transporter server and coordinating services in the server, and a route service for providing route information and a real-time road condition. This embodiment is described by using an example in which the server is a server of an aggregated service platform. In the embodiment shown in FIG. 8, operation 405 to operation 407 may be replaced with operation 501 to operation 503.

Operation 501: A platform service calculates a traffic light nearest to a driver according to a location of the driver. A determining process shown in FIG. 4 is performed. When it is determined that the status information of the traffic light needs to be displayed, operation 502 is performed.

Exemplarily, the platform service may perform the determining process shown in FIG. 4 in real time according to the location of the service provider, to determine whether the passenger end needs to display status information of a traffic light. If the status information of the traffic light needs to be displayed, the status information of the traffic light is obtained from the route service and is transmitted to the passenger end for displaying. If the status information of the traffic light does not need to be displayed, the status information of the traffic light does not need to be obtained. Exemplarily, the platform service may periodically perform this operation.

Operation 502: The platform service requests status information of the nearest traffic light from a route service. The route service returns the status information of the nearest traffic light to the platform service. The platform service transmits the status information of the nearest traffic light to the passenger end.

Operation 503: The passenger end renders and displays the status information of the traffic light after obtaining the status information of the traffic light.

Exemplarily, the passenger end receives the status information of the traffic light transmitted by the server, and displays the status information of the first traffic light. The server is configured to determine the first traffic light nearest to the service provider in a traveling direction of the service provider on the traveling route, and transmit the status information of the first traffic light to the passenger end in response to the service provider satisfying a target condition.

In conclusion, according to the method provided in this embodiment, the server may calculate the distance between the service provider and the next traffic light in real time, and transmit the status information of the next traffic light to the passenger end in real time when the service provider approaches the next traffic light. Therefore, the passenger end displays the status information of the next traffic light in real time, and the passenger determines a traveling status of the service provider combined with the status of the traffic light. By enriching the traffic light data at the pick-up waiting stage, the waiting anxiety of the passenger is relieved, the authenticity of waiting experience is also increased, the order cancellation rate is further lowered, and the public praise by users is improved.

Exemplarily, the driver end may alternatively actively report the status information of the latest traffic light.

FIG. 10 is a flowchart of a method for processing information in a travel service according to an exemplary embodiment of the present disclosure. The method may be performed by the first terminal, the server, and the driver end in FIG. 1. The server includes: a platform service for communicating with a passenger end and a transporter server. This embodiment is described by using an example in which the server is a server of an aggregated service platform. In the embodiment shown in FIG. 8, operation 405 to operation 407 may be replaced with operation 601 to operation 604.

Operation 601: A driver end calculates a traffic light nearest to a driver and obtains status information of the traffic light.

For example, the driver end needs to display the status information of the traffic light to assist the driver in driving. The driver end may actively report the status information of the traffic light to the server when necessary.

Operation 602: The driver end provides the status information of the nearest traffic light to a platform service.

For example, the driver end may periodically perform the determining process shown in FIG. 4, to determine whether the passenger end needs to display the status information of the traffic light. When the passenger end needs to display the status information of the traffic light, the driver end actively provides the status information of the next traffic light to the server, so that the server forwards the status information of the next traffic light to the passenger end for displaying.

For example, when the server is a server of a travel service platform and the driver end is a client of the travel service platform, the driver end may directly transmit the status information of the next traffic light to the server.

When the server is a server of an aggregated service platform, and the driver end is a driver end of a travel service platform aggregated by the aggregated service platform, the driver end may first report the status information of the next traffic light to the server (the transporter server) of the travel service platform, and then the transporter server forwards the status information of the next traffic light to the server of the aggregated service platform.

Operation 603: The platform service transmits the status information of the nearest traffic light to the passenger end.

Operation 604: The passenger end renders and displays the status information of the traffic light after obtaining the status information of the traffic light.

Exemplarily, the passenger end receives the status information of the first traffic light transmitted by the server and displays the status information of the first traffic light. The server is configured to receive the status information of the first traffic light reported by the driver end. The driver end is configured to determine the first traffic light nearest to the service provider in a traveling direction of the service provider on the traveling route, and report the status information of the first traffic light to the server in response to the service provider satisfying a target condition.

In conclusion, according to the method provided in this embodiment, the driver end obtains the status information of the next traffic light, so as to remind the driver of the status of the next traffic light in real time. The driver end may directly report this part of information to the server, so that the server synchronizes the status information of the traffic light to the passenger end, and transmits the status information of the next traffic light to the passenger end in real time. Therefore, the passenger end displays the status information of the next traffic light in real time, and the passenger determines a traveling status of the service provider combined with the status of the traffic light. The method can reduce the operational load of the passenger end and the server, and improve the synchronization efficiency of traffic light data. By enriching the traffic light data at the pick-up waiting stage, the waiting anxiety of the passenger is relieved, the authenticity of waiting experience is also increased, the order cancellation rate is further lowered, and the public praise by users is improved.

Apparatus embodiments of the present disclosure are described below. For details not described in detail in the apparatus embodiments, refer to the corresponding records in the above method embodiments.

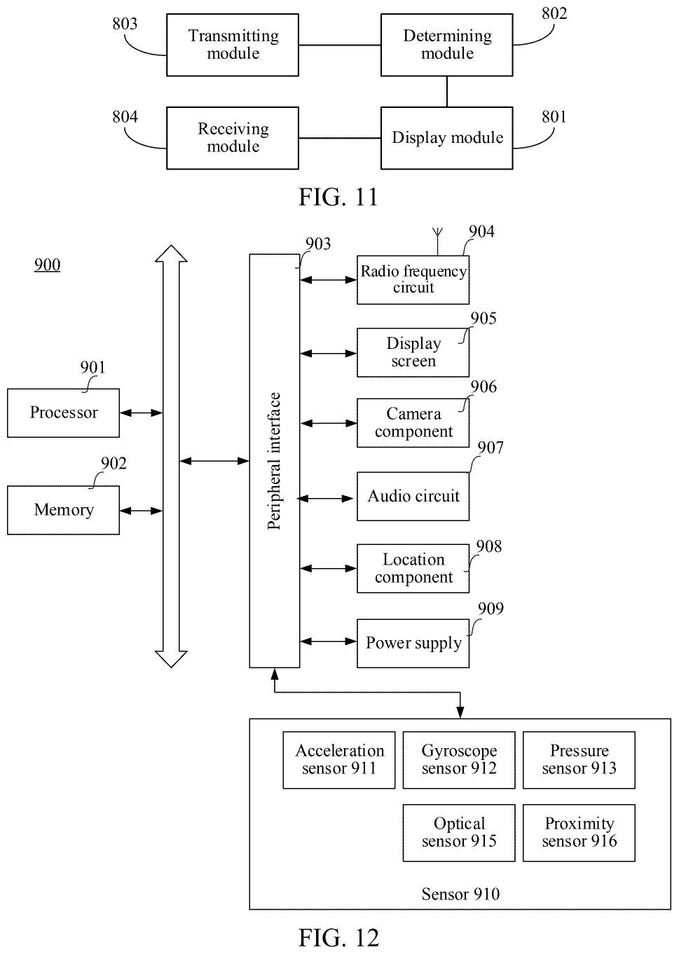

FIG. 11 is a block diagram of an apparatus for processing information in a travel service according to an embodiment of the present disclosure. The apparatus includes:
a display module 801, configured to display a waiting interface at a pick-up waiting stage, the waiting interface displaying a location identifier of a service provider and a traveling route from the service provider to a pick-up point, the traveling route including a first location where a first traffic light is located; the first traffic light being a traffic light nearest to the service provider, a traffic light having a distance with the service provider less than a first distance threshold, or a traffic light whose distance from the service provider is less than a preset threshold in a traveling direction of the service provider;
the display module 801, configured to display status information of the first traffic light on the waiting interface when a distance of the service provider satisfies a target condition; and
the display module 801, configured to eliminate the status information of the first traffic light on the waiting interface after the service provider passes by the first location.

The apparatus for processing information in a travel service provided in the foregoing embodiment is illustrated only with an example of division of the foregoing functional modules. The term module (and other similar terms such as submodule, unit, subunit, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. In actual applications, the foregoing functions may be allocated to and completed by different functional modules based on requirements. That is, an internal structure of the apparatus is divided into different functional modules to complete all or some of the functions described above. In addition, the apparatus for processing information in a travel service provided in the foregoing embodiment belongs to the same idea as the embodiments of the method for processing information in a travel service. Details of a specific implementation process may refer to the method embodiment, and details are not described herein again.

The present disclosure further provide a terminal, including a processor and a memory, the memory having at least one instruction stored therein, and the at least one instruction being loaded and executed by the processor, to implement the method for processing information in a travel service according to the foregoing method embodiments. The terminal may be a terminal provided in FIG. 12 below.

FIG. 12 is a structural block diagram of a terminal 900 according to an exemplary embodiment of the present disclosure. The terminal 900 may be a smartphone, a tablet computer, a Moving Picture Experts Group Audio Layer III (MP3) player, a Moving Picture Experts Group Audio Layer IV (MP4) player, a notebook computer, or a desktop computer. The terminal 900 may alternatively be referred to as another name such as user equipment, a portable terminal, a laptop terminal, or a desktop terminal.

Generally, the terminal 900 includes a processor 901 and a memory 902.

The processor 901 may include one or more processing cores, for example, a 4-core processor or an 8-core processor. The processor 901 may be implemented in at least one hardware form of a digital signal processor (DSP), a field-programmable gate array (FPGA), and a programmable logic array (PLA). The processor 901 may alternatively include a main processor and a coprocessor. The main processor is a processor configured to process data in an awake state, and is also referred to as a central processing unit (CPU). The coprocessor is a low power consumption processor configured to process the data in a standby state. In some embodiments, the processor 901 may be integrated with a graphics processing unit (GPU). The GPU is configured to render and draw content that needs to be displayed on a display screen. In some embodiments, the processor 901 may further include an artificial intelligence (AI) processor. The AI processor is configured to process computing operations related to machine learning.

The memory 902 may include one or more computer-readable storage media. The computer-readable storage medium may be non-transient. The memory 902 may further include a high-speed random access memory and a nonvolatile memory, for example, one or more disk storage devices or flash storage devices. In some embodiments, the non-transient computer-readable storage medium in the memory 902 is configured to store at least one instruction, and the at least one instruction is configured for being executed by the processor 901 to implement the method for processing information in a travel service provided in the method embodiments of the present disclosure.

In some embodiments, the terminal 900 may alternatively include: a peripheral interface 903 and at least one peripheral. The processor 901, the memory 902, and the peripheral interface 903 may be connected by using a bus or a signal cable. Each peripheral may be connected to the peripheral interface 903 by using a bus, a signal cable, or a circuit board. Specifically, the peripheral includes: at least one of a radio frequency (RF) circuit 904, a display screen 905, a camera component 906, an audio circuit 907, a location component 908, and a power supply 909.

The peripheral interface 903 may be configured to connect the at least one peripheral related to input/output (I/O) to the processor 901 and the memory 902. In some embodiments, the processor 901, the memory 902, and the peripheral interface 903 are integrated on a same chip or circuit board. In some other embodiments, any one or two of the processor 901, the memory 902, and the peripheral interface 903 may be implemented on a single chip or circuit board. This is not limited in this embodiment.

The RF circuit 904 is configured to receive and transmit an RF signal, also referred to as an electromagnetic signal. The RF circuit 904 communicates with a communication network and other communication devices by using the electromagnetic signal. The RF circuit 904 converts an electric signal into an electromagnetic signal for transmission, or converts a received electromagnetic signal into an electric signal. In some embodiments, the RF circuit 904 includes: an antenna and feeder system, an RF transceiver, one or more amplifiers, a tuner, an oscillator, a digital signal processor, a codec chip set, a subscriber identity module card, and the like. The RF circuit 904 may communicate with other terminals through at least one wireless communication protocol. The wireless communication protocol includes, but is not limited to, a world wide web, a metropolitan area network, an intranet, generations of mobile communication networks (2G, 3G, 4G, and 5G), a wireless local area network and/or a wireless fidelity (Wi-Fi) network. In some embodiments, the RF 904 may further include a circuit related to near field communication (NFC). This is not limited in the present disclosure.

The display screen 905 is configured to display a user interface (UI). The UI may include a graph, text, an icon, a video, and any combination thereof. When the display screen 905 is a touch display screen, the display screen 905 further has a capability of acquiring a touch signal on or above a surface of the display screen 905. The touch signal may be input to the processor 901 as a control signal for processing. In this case, the display screen 905 may further be configured to provide a virtual button and/or a virtual keyboard that are/is also referred to as a soft button and/or a soft keyboard. In some embodiments, there may be one display screen 905, disposed on a front panel of the terminal 900. In some other embodiments, there may be at least two display screens 905, respectively disposed on different surfaces of the terminal 900 or designed in a foldable shape. In still some other embodiments, the display screen 905 may be a flexible display screen, disposed on a curved surface or a folded surface of the terminal 900. Even, the display screen 905 may be further set in a non-rectangular irregular pattern, namely, a special-shaped screen. The display screen 905 may be prepared by using materials such as a liquid crystal display (LCD), an organic light-emitting diode (OLED), or the like.

The camera component 906 is configured to collect images or videos. In some embodiments, the camera component 906 includes a front-facing camera and a rear-facing camera. Generally, the front-facing camera is disposed on the front panel of the terminal, and the rear-facing camera is disposed on a back surface of the terminal. In some embodiments, there are at least two rear-facing cameras, which are respectively any of a main camera, a depth-of-field camera, a wide-angle camera, and a telephoto camera, to achieve background blur through fusion of the main camera and the depth-of-field camera, panoramic photographing and virtual reality (VR) photographing through fusion of the main camera and the wide-angle camera, or other fusion photographing functions. In some embodiments, the camera component 906 may further include a flash. The flash may be a monochrome temperature flash, or may be a double color temperature flash. The double color temperature flash refers to a combination of a warm light flash and a cold light flash, and may be configured for light compensation under different color temperatures.

The audio circuit 907 may include a microphone and a speaker. The microphone is configured to acquire sound waves of a user and an environment, and convert the sound waves into an electrical signal to input to the processor 901 for processing, or input to the RF circuit 904 for implementing voice communication. For the purpose of stereo sound collection or noise reduction, there may be a plurality of microphones, respectively arranged at different parts of the terminal 900. The microphone may further be an array microphone or an omni-directional acquisition type microphone. The speaker is configured to convert the electrical signal from the processor 901 or the RF circuit 904 into sound waves. The speaker may be a film speaker, or may be a piezoelectric ceramic speaker. When the speaker is the piezoelectric ceramic speaker, the speaker not only can convert an electric signal into acoustic waves audible to a human being, but also can convert an electric signal into acoustic waves inaudible to a human being, for ranging and other purposes. In some embodiments, the audio circuit 907 may further include an earphone jack.

The location component 908 is configured to position a current geographic location of the terminal 900, to implement a navigation or a location based service (LBS). The location component 908 may be a location component based on the Global Positioning System (GPS), the BeiDou system, or the Galileo system.

The power supply 909 is configured to supply power to components in the terminal 900. The power supply 909 may be an alternating current, a direct current, a primary battery, or a rechargeable battery. When the power supply 909 includes a rechargeable battery, and the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery may be further configured to support a fast charging technology.

In some embodiments, the terminal 900 further includes one or more sensors 910. The one or more sensors 910 include but are not limited to an acceleration sensor 911, a gyroscope sensor 912, a pressure sensor 913, an optical sensor 915, and a proximity sensor 916.

The acceleration sensor 911 may detect a magnitude of acceleration on three coordinate axes of a coordinate system established with the terminal 900. For example, the acceleration sensor 911 may be configured to detect components of gravity acceleration on the three coordinate axes. The processor 901 may control, according to a gravity acceleration signal collected by the acceleration sensor 911, the display screen 905 to display the user interface in a landscape view or a portrait view. The acceleration sensor 911 may be further configured to acquire motion data of a game or a user.

The gyroscope sensor 912 may detect a body direction and a rotation angle of the terminal 900, and may work with the acceleration sensor 911 to acquire a 3D action performed by the user on the terminal 900. The processor 901 may implement the following functions according to the data acquired by the gyroscope sensor 912: motion sensing (such as changing the UI according to a tilt operation of the user), image stabilization at photographing, game control, and inertial navigation.

The pressure sensor 913 may be arranged at a side frame of the terminal 900 and/or a lower layer of the display screen 905. When the pressure sensor 913 is arranged at the side frame of the terminal 900, a holding signal of the user on the terminal 900 may be detected. The processor 901 performs left and right hand recognition or a quick operation according to the holding signal collected by the pressure sensor 913. When the pressure sensor 913 is arranged at the lower layer of the display screen 905, the processor 901 implements control of an operable control on a UI interface based on a pressure operation on the display screen 905 by a user. The operable control includes at least one of a button control, a scroll-bar control, an icon control, and a menu control.

The optical sensor 915 is configured to acquire ambient light intensity. In an embodiment, the processor 901 may control display brightness of the display screen 905 according to the ambient light intensity collected by the optical sensor 915. Specifically, when the ambient light intensity is relatively high, the display brightness of the touch display screen 905 is increased. When the ambient light intensity is relatively low, the display brightness of the touch display screen 905 is decreased. In another embodiment, the processor 901 may further dynamically adjust a photographing parameter of the camera component 906 according to the ambient light intensity collected by the optical sensor 915.

The proximity sensor 916, alternatively referred to as a distance sensor, is generally arranged on the front panel of the terminal 900. The proximity sensor 916 is configured to acquire a distance between the user and the front surface of the terminal 900. In an embodiment, when the proximity sensor 916 detects that the distance between the user and the front surface of the terminal 900 gradually becomes smaller, the display screen 905 is controlled by the processor 901 to switch from a screen-on state to a screen-off state. When the proximity sensor 916 detects that the distance between the user and the front surface of the terminal 900 gradually becomes larger, the display screen 905 is controlled by the processor 901 to switch from the screen-off state to the screen-on state.

A person skilled in the art can understand that the structure shown in FIG. 12 does not constitute a limitation to the terminal 900, and the terminal may include more or fewer components than those shown in the figure, or some components may be combined, or a different component arrangement may be used.

The memory also includes one or more programs, which are stored in the memory and include the method for processing information in a travel service provided in the embodiments of the present disclosure

The present disclosure provides a computer-readable storage medium, having at least one instruction stored therein. The at least one instruction is loaded and executed by a processor to implement the method for processing information in a travel service provided in the above method embodiments.

The present disclosure further provides a computer program product or a computer program. The computer program product or the computer program includes computer instructions. The computer instructions are stored in a computer-readable storage medium. A processor of a computer device reads the computer instructions from the computer-readable storage medium, and the processor executes the computer instructions, so that the computer device performs the method for processing information in a travel service provided in the foregoing embodiments.

The sequence numbers of the foregoing embodiments of the present disclosure are merely for description purpose but do not imply the preference among the embodiments.

A person of ordinary skill in the art may understand that all or some of the operations of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

The foregoing descriptions are merely exemplary embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A method comprising:
displaying a waiting interface at a pick-up waiting stage, the waiting interface displaying a location identifier of a service provider and a traveling route from the service provider to a pick-up point, the traveling route comprising a first location where a first traffic light is located; the first traffic light being a traffic light nearest to the service provider or a traffic light whose distance from the service provider is less than a preset threshold in a traveling direction of the service provider;
displaying status information of the first traffic light on the waiting interface in response to the service provider satisfying a target condition; and
eliminating the status information of the first traffic light on the waiting interface after the service provider passes by the first location.

2. The method according to claim 1, wherein the target condition comprises at least one of:
a distance between the service provider and the pick-up point is less than a first distance threshold;
a distance between the service provider and the first location is less than a second distance threshold; or
a movement distance of the service provider within a first duration is less than a third distance threshold.

3. The method according to claim 1, wherein the displaying status information of the first traffic light on the waiting interface in response to the service provider satisfying a target condition comprises:
obtaining the status information of the first traffic light in response to the service provider satisfying the target condition, wherein the status information comprises a light-on status and countdown of the corresponding light-on status, and the light-on status comprises at least one of: a red light being on, a green light being on, or a yellow light being on; and
displaying the status information of the first traffic light in response to the countdown being greater than a second duration, and further displaying prompt information that the service provider is waiting for the green light in response to that the light-on status is the red light being on being on.

4. The method according to claim 3, further comprising:
displaying a traffic light identifier at the first location and displaying prompt information that the service provider is waiting for the green light in response to that the status information is not obtained.

5. The method according to claim 1, further comprising:
displaying the status information of the first traffic light and prompt information of road congestion in response to that a movement distance of the service provider within the first duration is less than the third distance threshold and the light-on status is the green light being on.

6. The method according to claim 1, wherein the displaying the waiting interface at the pick-up waiting stage comprises:
transmitting a route obtaining request to a server at the pick-up waiting stage;
receiving a real-time route transmitted by the server, the real-time route comprising a location of the service provider and the traveling route; and
displaying the waiting interface according to the real-time route.

7. The method according to claim 1, wherein the method further comprises: determining the first traffic light on the traveling route; and
the displaying status information of the first traffic light on the waiting interface in response to the service provider satisfying a target condition comprises:
transmitting a light-on status obtaining request to a server in response to that the service provider satisfies the target condition, the light-on status obtaining request being configured to request the status information of the first traffic light;
receiving the status information of the first traffic light transmitted by the server; and
displaying the status information of the first traffic light.

8. The method according to claim 1, wherein the displaying status information of the first traffic light on the waiting interface in response to the service provider satisfying a target condition comprises:
receiving the status information of the first traffic light transmitted by a server; and
displaying the status information of the first traffic light, wherein
the server is configured to determine the first traffic light; and transmit the status information of the first traffic light to the computing device on the passenger end in response to that the service provider satisfies the target condition.

9. The method according to claim 6, wherein the displaying status information of the first traffic light on the waiting interface in response to the service provider satisfying a target condition comprises:
receiving the status information of the first traffic light transmitted by the server; and
displaying the status information of the first traffic light, wherein
the server is configured to receive the status information of the first traffic light reported by a driver end device; the driver end device is configured to determine the first traffic light, and report the status information of the first traffic light to the server in response to that the service provider satisfies the target condition.

10. An apparatus comprising:
a processor and a memory, the memory having at least one instruction, at least one program, a code set, or an instruction set stored therein, the at least one instruction, the at least one program, the code set, or the instruction set being loaded and executed by the processor, to perform:
displaying a waiting interface at a pick-up waiting stage, the waiting interface displaying a location identifier of a service provider and a traveling route from the service provider to a pick-up point, the traveling route comprising a first location where a first traffic light is located; the first traffic light being a traffic light nearest to the service provider or a traffic light whose distance from the service provider is less than a preset threshold in a traveling direction of the service provider;
displaying status information of the first traffic light on the waiting interface in response to the service provider satisfying a target condition; and
eliminating the status information of the first traffic light on the waiting interface after the service provider passes by the first location.

11. The apparatus according to claim 10, wherein the target condition comprises at least one of:
a distance between the service provider and the pick-up point being less than a first distance threshold;
a distance between the service provider and the first location being less than a second distance threshold; or
a movement distance of the service provider within a first duration being less than a third distance threshold.

12. The apparatus according to claim 10, wherein the displaying status information of the first traffic light on the waiting interface in response to the service provider satisfying a target condition comprises:
obtaining the status information of the first traffic light in response to the service provider satisfying the target condition, wherein the status information comprises a light-on status and countdown of the corresponding light-on status, and the light-on status comprises at least one of:
a red light being on, a green light being on, or a yellow light being on; and
displaying the status information of the first traffic light in response to the countdown being greater than a second duration, and further displaying prompt information that the service provider is waiting for the green light in response to that the light-on status is the red light being on being on.

13. The apparatus according to claim 12, wherein the processor is further configured to implement:
displaying a traffic light identifier at the first location and displaying prompt information that the service provider is waiting for the green light in response to that the status information is not obtained.

14. The apparatus according to claim 10, wherein the processor is further configured to implement:
displaying the status information of the first traffic light and prompt information of road congestion in response to that a movement distance of the service provider within the first duration is less than the third distance threshold and the light-on status is the green light being on.

15. The apparatus according to claim 10, wherein the displaying the waiting interface at the pick-up waiting stage comprises:
transmitting a route obtaining request to a server at the pick-up waiting stage;
receiving a real-time route transmitted by the server, the real-time route comprising a location of the service provider and the traveling route; and
displaying the waiting interface according to the real-time route.

16. The apparatus according to claim 10, wherein the processor is further configured to determine the first traffic light on the traveling route; and
the displaying status information of the first traffic light on the waiting interface in response to the service provider satisfying a target condition comprises:
transmitting a light-on status obtaining request to a server in response to that the service provider satisfies the target condition, the light-on status obtaining request being configured to request the status information of the first traffic light;
receiving the status information of the first traffic light transmitted by the server; and
displaying the status information of the first traffic light.

17. The apparatus according to claim 10, wherein the displaying status information of the first traffic light on the waiting interface in response to the service provider satisfying a target condition comprises:
receiving the status information of the first traffic light transmitted by a server; and
displaying the status information of the first traffic light, wherein
the server is configured to determine the first traffic light; and transmit the status information of the first traffic light to the computing device on the passenger end in response to that the service provider satisfies the target condition.

18. The apparatus according to claim 15, wherein the displaying status information of the first traffic light on the waiting interface in response to the service provider satisfying a target condition comprises:
receiving the status information of the first traffic light transmitted by the server; and
displaying the status information of the first traffic light, wherein
the server is configured to receive the status information of the first traffic light reported by a driver end device; the driver end device is configured to determine the first traffic light, and report the status information of the first traffic light to the server in response to that the service provider satisfies the target condition.

19. A non-transitory computer-readable storage medium, having at least one instruction, at least one program, a code set, or an instruction set stored therein, the at least one instruction, the at least one program, the code set, or the instruction set being loaded and executed by a processor, to perform:
displaying a waiting interface at a pick-up waiting stage, the waiting interface displaying a location identifier of a service provider and a traveling route from the service provider to a pick-up point, the traveling route comprising a first location where a first traffic light is located; the first traffic light being a traffic light nearest to the service provider or a traffic light whose distance from the service provider is less than a preset threshold in a traveling direction of the service provider;
displaying status information of the first traffic light on the waiting interface in response to the service provider satisfying a target condition; and
eliminating the status information of the first traffic light on the waiting interface after the service provider passes by the first location.

20. The storage medium according to claim 19, wherein the target condition comprises at least one of:
a distance between the service provider and the pick-up point being less than a first distance threshold;
a distance between the service provider and the first location being less than a second distance threshold; or
a movement distance of the service provider within a first duration being less than a third distance threshold.
